(19) United States
(12) Patent Application Publication
(10) Pub. No.: US 2026/0025754 A1
(43) Pub. Date: Jan. 22, 2026

(54) DYNAMIC RESOURCE OPTIMIZATION IN A WIRELESS COMMUNICATION NETWORK

(71) Applicant: Rakuten Symphony, Inc., Tokyo (JP)

(72) Inventors: Ronak Bharatkumar LALWALA, Bangalore (IN); Manjari CHHAWCHHARIA, Bangalore (IN); Gopi RAVINDRAN, Bangalore (IN)

(21) Appl. No.: 18/908,842

(22) Filed: Oct. 8, 2024

(30) Foreign Application Priority Data
Jul. 17, 2024 (IN) 202441054673

(51) Int. Cl. H04W 52/02; H04W 28/088

(52) U.S. Cl. CPC H04W 52/0206; H04W 28/088

(57) ABSTRACT

Embodiments disclosed herein provide a method and system for sending current traffic parameters pertaining to a Distribution unit (DU) comprising multiple processing cores, to a network entity. Further, in response to sending the current traffic parameters, the DU receives a first limit of Radio Resource Control (RRC)-connected User Equipments (UEs) and second limit of Physical Resource Blocks (PRBs), from the network entity. Furthermore, based on the first limit and the second limit, the DU transitions a set of processing cores, from the plurality of processing cores, from a first power state to a second power state.

### RELATED APPLICATIONS

The present application claims priority based on Indian Patent Application number 202441054673, filed Jul. 17, 2024.

### TECHNICAL FIELD

The present disclosure generally relates to the field of power saving techniques for distributed unit nodes in a wireless communication network, and more particularly relates to performing managing power saving states in processing cores of a network entity in wireless communication network.

### BACKGROUND

The information disclosed in this background section is only for enhancement of understanding of the general background of the disclosure and should not be taken as an acknowledgement or any form of suggestion that this information forms the prior art already known to a person skilled in the art.

A Radio Access Network (RAN) infrastructure is used in a mobile telecommunications network, such as a mobile broadband network, to connect User Equipment (UE) to a core network. In one implementation of a network architecture, the RAN includes network nodes. The network nodes may be embodied as base-station Central Unit (CU) in communication with a plurality of network entities. For example, the network entities may be base station Distributed Units (DUs). The UE may be connected to a network entity associated with the O-RAN. The RAN is configured to handle functionalities, including, but not limited to, interconnecting UEs and network entities in a network with each other through radio link(s) for subscribers to use the services of the core network.

Network entities, such as the base station DU, have been evolved to support enhanced user capabilities by supporting increased data rates and increased network reliability for the connect UEs. With a drastic increase in a number of UEs connected to a network entity, handling a substantial increase in overall data traffic requires an increased power consumption by the network entity. The network entities include multiple processing cores implemented in a distributed architecture for handling the substantial traffic load and network operations requirements. Such an increase in the power consumption has raised difficulty in achieving optimal energy efficiency with respect to the power consumption of the network entities.

### SUMMARY

The present disclosure relates to a method comprising the steps of sending, by a Distribution unit (DU) associated to a wireless communication network, current traffic parameters, pertaining to the DU, to a network entity, wherein the DU comprises a plurality of processing cores. Further, the method comprises receiving, in response to sending the current traffic parameters, by the DU and from the network entity, a first limit of Radio Resource Control (RRC)-connected User Equipments (UEs) and second limit of Physical Resource Blocks (PRBs). The method also involves, based on the first limit and the second limit, transitioning, by the DU, a set of processing cores, from the plurality of processing cores, from a first power state to a second power state.

The present disclosure also relates to an apparatus configured to send, by a Distribution unit (DU) associated to a wireless communication network, current traffic parameters, pertaining to the DU, to a network entity, wherein the DU comprises a plurality of processing cores. Further, the method comprises, receive, in response to sending the current traffic parameters, by the DU and from the network entity, a first limit of Radio Resource Control (RRC)-connected User Equipments (UEs) and second limit of Physical Resource Blocks (PRBs). The apparatus is also configured, to based on the first limit and the second limit, transition, by the DU, a set of processing cores, from the plurality of processing cores, from a first power state to a second power state.

In an embodiment, there is a non-transitory computer readable medium including instructions stored thereon that when processed by at least one processor, cause the at least one processor to perform operations of sending, by a Distribution unit (DU) associated to a wireless communication network, current traffic parameters, pertaining to the DU, to a network entity, wherein the DU comprises a plurality of processing cores. Further, the at least one processor also perform operations of receive, in response to sending the current traffic parameters, by the DU and from the network entity, a first limit of Radio Resource Control (RRC)-connected User Equipments (UEs) and second limit of Physical Resource Blocks (PRBs). The at least one processor also performs operations of, based on the first limit and the second limit, transition, by the DU, a set of processing cores, from the plurality of processing cores, from a first power state to a second power state.

In multiple processing cores architecture of the network entities, effectively managing the overall power efficiency of the network entity is challenging. The methods and systems of the present disclosure allows to effectively manage power consumption of the network entity, including multiple processing cores architecture, based on contextual information relating to the traffic load and number of connected UE.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an exemplary environment for performing dynamic resource optimization in a distributed unit node of a wireless communication network, in accordance with some embodiments of the present disclosure.

FIG. 2 illustrates a block diagram of a network entity for performing dynamic resource optimization in a distributed unit node of a wireless communication network, in accordance with an embodiment of the present disclosure.

FIG. 3 illustrates an exemplary flow chart illustrating method steps for performing for performing dynamic resource optimization in a distributed unit node of a wireless communication network, in accordance with some embodiments of the present disclosure.

FIG. 4 illustrates an exemplary flow chart illustrating method steps for performing for performing dynamic resource optimization in a distributed unit node of a wireless communication network, in accordance with some embodiments of the present disclosure.

FIG. 5 illustrates an exemplary flow chart illustrating method steps for performing for performing dynamic resource optimization in a distributed unit node of a wireless communication network, in accordance with some embodiments of the present disclosure.

FIG. 6 illustrates an exemplary flow chart illustrating method steps for performing for performing dynamic resource optimization in a distributed unit node of a wireless communication network, in accordance with some embodiments of the present disclosure.

FIG. 7 illustrates an embodiment of a device wherein the method for performing for performing dynamic resource optimization in a distributed unit node of a wireless communication network may be implemented, according to the embodiments as disclosed herein.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE DISCLOSURE

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

In general, power management plays a critical role in achieving effective energy efficiency for multi-core processors. The base station DU, associated with a wireless communication network, may include a processor including a plurality of processing cores. Such processors may also be referred as a multi-core processor. Each core of the multi-core processor may be configured to handle the traffic load, including an Uplink (UL) data and a Downlink (DL) data. The UL and DL data may be associated to one or more UEs connected to the DU. However, as stated earlier, power management of such multi-core processor is a critical aspect to achieve an optimal energy efficiency while maintaining the required network performance standard. In scenarios, where one or more core are switched to a lower power state without consideration of a traffic load trend and proper estimation of number of UEs currently and actively communicating with the DU, the overall network performance may be degraded. Therefore, there is a requirement of dynamically optimization resources in the DU node based on contextual information relating to the traffic load and number of connected UE.

The methods and systems of the present disclosure solve a technical problem for effectively managing power consumption of the DU based on contextual information. Herein, techniques or mechanism may be required such that resource optimization and energy management associated with the DU may be performed with sufficient accuracy and reliability while maintaining the overall network performance. The present disclosure solves this technical problem as described in the embodiments below.

Embodiments disclosed herein provide a method and system for performing dynamic resource optimization and energy management associated with the DU based on accurate contextual information and predicted parameters pertaining to traffic conditions while maintaining required network performance. Therefore, the present disclosure suggests techniques for performing dynamic resource optimization and energy management associated with the DU.

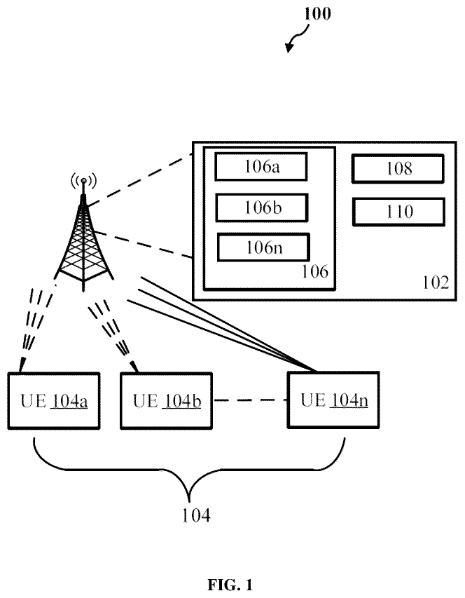

FIG. 1 illustrates an exemplary environment 100 for performing dynamic resource optimization in a distributed unit (DU) node 102 of a wireless communication network, in accordance with some embodiments of the present disclosure.

As shown in FIG. 1, the exemplary environment 100 includes a Base Station (BS) DU 102 and a plurality of User Equipment (UEs) 104a, 104b, . . . , 104n (also referred hereinafter collectively referred to as plurality of UEs 104). The plurality of UEs 104 may refer to the UEs in communication with the DU 102 in the communication network (not shown). Each of the plurality of UEs 104 may include, but not limited to, a cellular phone or smart phone, a pager, a laptop computer, a desktop computer, a wireless handset, a portable communication device, a portable computing device (e.g., a personal data assistant), or any other suitable computing device or other equipment/sensors including a wired or wireless communications interface. According to an embodiment of the present disclosure, the DU 102 may be designed to run on or in a “cloud” environment based on traffic demand.

In an embodiment, the DU 102 includes a processor 106 including a plurality of processing cores 106a, 106b, . . . , 106n (also referred hereinafter collectively referred to as plurality of processing cores 106 or cores 106). In an embodiment, the processor 106 may be a CPU configured for managing the plurality of processing cores 106a, 106b, . . . , 106n. Further, the DU 102 includes a memory 108. In some embodiments, the memory 108 may be communicatively coupled to the plurality of processing cores 106.

In an embodiment, the processor 106 may be integrated in the DU 102. In another embodiment, functionalities of the processor 106 for managing the plurality of processing cores 106a, 106b, . . . , 106n may be implemented in a CPU associated to a variety of computing systems, such as, a server, a cloud computing system, a network server, a cloud-based server, and the like. In an embodiment, the CPU may pertain to a dedicated server or may pertain to a cloud-based server. In an example, the CPU may be external to the DU 102 and communicatively coupled to the DU 102 via the communication network. In some embodiments, a dedicated memory may be communicatively coupled to the CPU. The dedicated memory stores instructions, executable by the CPU, which, on execution, may cause the CPU to perform dynamic management of the cores 106, as disclosed in the present disclosure.

In an embodiment the communication network through which the DU 102 and the UEs 104 are connected may include, without limitation, a direct interconnection, Local Area Network (LAN), Wide Area Network (WAN), Controller Area Network (CAN), wireless network (e.g., using a Wireless Application Protocol), the Internet, and the like. The communication network may include 4G or 5G communication network.

The 5G communication network, for example, is configured with a disaggregated BS (or gNodeBs (gNB)) architecture defined for cellular network. For example, a disaggregated Next Generation Node B (gNB) architecture is defined in 3rd Generation Partnership Project (3GPP) decomposing a gNB into multiple logical entities. For example, the gNB may include a gNB-Control Unit-Control Plane (CU-CP) (not shown in figures), gNB-Control Unit-User Plane (CU-UP) (not shown in figures) and the gNB DU (similar to the DU 102). Likewise, a single DU may be responsible to host multiple cells (not shown in figures). As an example, a single DU may be responsible to host a maximum of 512 cells in current 3GPP specifications. The gNB-CU-CP may host a Packet Data Convergence Protocol (PDCP-c) and a Radio Resource Control (RRC) layer (not shown in figures), gNB-CU-UP may host a Packet Data Convergence Protocol (PDCP-u) and a Service Data Adaptation Protocol (SDAP) while the gNB-DU hosts a Radio Link Control (RLC), a Medium Access Control (MAC), and a Physical (PHY) layer. Herein, scheduling operation takes place at the gNB-DU. Further, the DU 102 may support a first network layer (L1) and a second network layer (L2) in the disaggregated gNB architecture.

In operation, the DU 102 may send associated current traffic parameters to a network entity. The network entity may include one of the CU-CP, a near real-time Radio Access Network (RAN) Intelligent Controller (RIC), a RAN node, and a Service Management and Orchestration (SMO) framework. In an example, the SMO layer may comprise a non-real-time Radio Access Network (RAN) Intelligent Controller (RIC). In an example, the current traffic data pertains to Key Performance Indicators (KPIs) associated with the RRC-connected UEs and the PRBs. For example, the DU 102 may be in communication with the plurality of UEs 104, which are in the RRC connected mode and actively communicating with the DU 102. In an example, the DU 102 may be in communication with the UE 104 via a communication channel (not shown).

In an embodiment, the DU 102 may receive a first limit of Radio Resource Control (RRC)-connected User Equipments (UEs) and second limit of Physical Resource Blocks (PRBs), from the network entity and by the DU 102, in response to sending the current traffic parameters.

In an embodiment, the DU 102 may, based on the first limit and the second limit, transition a set of processing cores, from the plurality of processing cores, from a first power state to a second power state.

In an embodiment, the first network layer, associated with the DU 102, may receive the first limit and the second limit. Further, the first network layer may dynamically transition a set of processing cores, from the plurality of processing cores, from a first power state to a second power state based on the first limit. Furthermore, the first network layer may transmit the second limit to the second network layer associated with the DU 102. In an embodiment, the second network layer may dynamically transition a set of processing cores, from the plurality of processing cores, from a first power state to a second power state based on the second limit.

In an embodiment, the network entity may implement a Machine Learning (ML) engine (not shown in FIG. 1) for predicting traffic parameters (also referred hereinafter as predicted traffic data or predicted traffic parameters) in response to receiving the current traffic parameters by network entity from the DU. In an example, the predicted traffic data may pertain to data traffic trend classified, by the ML engine, based on at least one of a time of a day and day of a week. For example, the ML engine may be implemented, based on one or more input parameters. The ML engine may be implemented to create an environment such that a learning agent, associated with the environment, may be configured to predict the traffic data.

In an embodiment, the learning agent, to predict the traffic data, may be configured to obtain the one or more input parameters. Examples of the one or more input parameters may include, but not limited to, traffic data associated with a time in a single day, traffic data associated with a day of the week, a number of UEs 104 connected to the DU 102. Based on the one or more input parameters, the learning agent may be configured to predict, for a given time in a single day and/or at a given day of the week, at least one of a number of UEs in RRC connected mode and a number of UEs is sleep mode, a number of UEs in RRC connected mode and a number of UEs is sleep mode, traffic congestion, channel occupancy, overall UL traffic data load, overall DL traffic data load, etc. Further, the learning agent may be configured to provide the predicted traffic data as an input to the ML engine. The learning agent may be pre-trained on pre-collected and normalized traffic conditions and parameters associated with a given time of a single day and a given day of a week.

In an embodiment, the network entity determines the first limit and the second limit, based on the current traffic parameters, received from the DU, and the predicted traffic parameters.

In an alternative embodiment, the DU 102 may receive predicted traffic parameters from the network entity. Further, the DU 102 may determine, based on the current traffic data and predicted traffic data, a first limit of Radio Resource Control (RRC)-connected UEs 104 and second limit of Physical Resource Blocks (PRBs). For example, the current traffic data may include Key Performance Indicators (KPIs) available from associated RAN nodes. By considering the current traffic data along with the predicted traffic data, the DU 102 may be able to compare the predicted traffic conditions with the real-time traffic conditions. Such comparison enables the DU 102 to take informed decision and dynamically allocate resources to the cores 106 or transitions a set of cores 106 into a high or low power states.

In an embodiment, the DU 102 may, based on the first limit, determine a number of processing cores from the plurality of processing cores 106, required for the first network layer.

In an embodiment, the DU 102 may, based on the second limit determine a number of processing cores from the plurality of processing cores 106, of the DU required for the second network layer. In an embodiment, based on the first limit and the second limit, the DU 102 or one of the first network layer and the second network layer may transition a set of cores from a first power state to a second power state.

In an embodiment, based on a scenario that the first limit is increased, the DU 102 is configured to dynamically transition a set of processing cores from the plurality of processing cores 106, in a high power state from a corresponding low power state. For example, in a scenario in which the limit of Radio Resource Control (RRC)-connected UEs 104 is increased, the set of processing cores from the plurality of processing cores 106, may be transitioned into the high power state to accommodate the increased traffic load, and, thereby, maintaining a required network performance.

In an alternate embodiment, based on a scenario that the first limit is decreased, the DU 102 is configured to dynamically transition a set of processing cores from the plurality of processing cores 106, in a low power state from a corresponding high power state. For example, in a scenario in which the limit of Radio Resource Control (RRC)-connected UEs 104 in decreased, the set of processing cores from the plurality of processing cores 106 may be transitioned into the low power state to reduce power consumption utilized by the processing cores 106, and, thereby, achieving power efficiency.

In an embodiment, based on a scenario that the second limit is increased, the DU 102 is configured to dynamically transition a set of processing cores from the plurality of processing cores 106, in a high power state from a corresponding low power state. For example, in a scenario in which the limit of Physical Resource Blocks (PRBs) is increased, the set of processing cores from the plurality of processing cores 106, may be transitioned into the high power state to accommodate the increased traffic load, and, thereby, maintaining a required network performance.

In an alternate embodiment, based on a scenario that the second limit is decreased, the DU 102 is configured to dynamically transition a set of processing cores from the plurality of processing cores 106, in a low power state from a corresponding high power state. For example, in a scenario in which the limit of Physical Resource Blocks (PRBs) in decreased, the set of processing cores from the plurality of processing cores 106 may be transitioned into the low power state to reduce power consumption utilized by the processing cores 106, and, thereby, achieving power efficiency.

In an embodiment, the DU 102 may be configured to monitor one or more traffic parameters in real-time. For example, the traffic parameters may include, but are not limited to, UL channel congestion, DL channel congestion, number of UEs 104 connected to the DU 102, number of the UEs 104 in active communication with the DU 102, number of legacy UEs, number of advanced UEs, and so on. Further, the DU 102 may dynamically modify at least one of the first limit and the second limit based on the traffic parameters.

In the above embodiments, the first limit and the second limit may be embodied as the contextual information which is indicative of the traffic and network load insights. Such insights may be current or real-time information which is critical in determining whether to switch or transition a set of cores 106 into a high power state or a low power state. Therefore, by dynamically defining the first core optimization policy and the second core optimization policy, based on the contextual information, the DU 102 is able to achieve optimal energy efficiency while maintaining optimal network performance.

In an embodiment, the increase and decrease in the first and the second limit, respectively, is indicative of busy and non-busy periods in a network.

In an embodiment, the DU 102 may determine the current load associated with the plurality of processing cores 106 on the DU 102. In an example, a first network layer may be configured to monitor the current load associated with the plurality of processing cores 106 on the DU 102. Subsequently, the DU 102 may determine that the current load is above a first threshold based on the monitoring of the current load. Further, upon determining that the current load is above the first threshold, the DU 102 may dynamically increase the at least one of the first limit and the second limit.

In an embodiment, based on the monitoring of the current load, the DU 102 may determine that the current load is below a second threshold. Further, upon determining that the current load is below the second threshold, the DU 102 may dynamically decrease the at least one of the first limit and the second limit.

In an embodiment, the learning agent of the ML engine may be configured to dynamically optimize the resource allocation to a set of cores 106 based on the predicted traffic data. In an embodiment, the DU 102 may be configured to determine, based on the predicted traffic data, an optimal dynamic resource allocation for each of the one or more cores 106. In another embodiment, the learning agent of the ML engine may be configured to dynamically transition one or more cores 106 into one of a high power state and a low power state based on the predicted traffic data. For example, the optimal dynamic resource allocation may be indicative of increasing or decreasing the PRBs allocated to each of the cores 106 in order to allow the cores 106 to achieve an optimal performance without facing any congestion or bottlenecking.

In an embodiment, the DU 102 may be configured to apply the optimal dynamic resource allocation or the dynamic transitioning of cores 106 from one power state to another based on the first limit or the second limit, as described in detail in the above description. The dynamic optimization of the resource allocation and/or power state transitioning may allow the DU 102 to achieve an optimal energy efficiency while maintaining required network performance.

In an embodiment, the optimal dynamic resource allocation or the dynamic transitioning of cores 106 may be performed by implementing a core dimensioning mechanism based on a c-state based power saving technique. For example, the core dimensioning may include determination of a total number of cores 106 in the DU 102 including the plurality of cores 106. In an example, the plurality of cores 106 may include an L1 core and an L2 core. Further, it is determined that n cores are associated with L1 core, m cores are associated with L2 core. For achieving optimal power saving, the total number of active cores is to be less than the total number of cores present in the DU 102. Accordingly, n and m cores are dimensioned, such that the configuration maps to: maximum X PRBs supported in the DL and maximum of Y PRBs supported in the UL; and maximum number of RRC connected UEs. In the above example embodiment, the number of cores required for L1 is determined based on the PRB limit and the number of cores required for L2 is determined based on RRC connected UE limit and PRB limit.

The optimal dynamic resource allocation or dynamic power state transitioning is defined in the above examples in view of parameters including the first limit, second limit, predicted traffic data, and current traffic data. However, a person skilled in the art will appreciate that an optimal action of dynamic resource allocation or dynamic power state transitioning may also be applied considering a combination of the above parameters along with any additional traffic parameters.

In an embodiment, the environment of the ML engine may include a training agent. For example, the network entity may be configured to implement the training agent in the environment of the ML engine to train the learning agent based on historical traffic data. In an alternative embodiment, the DU 102 may be configured to implement the training agent in the environment of the ML engine to train the learning agent based on the historical traffic data. The historical traffic data may include pre-calculated traffic parameters and insights for corresponding time of day and/or day of week. Upon training, the learning agent may be capable of predicting the traffic data. Such prediction may provide data showcasing the traffic conditions which are expected related to a particular target time or duration in a target network. Such predictions allow determining precautionary measures which may be taken in order to optimize the overall power consumption of the DU 102 and maintaining the network performance to the required standard.

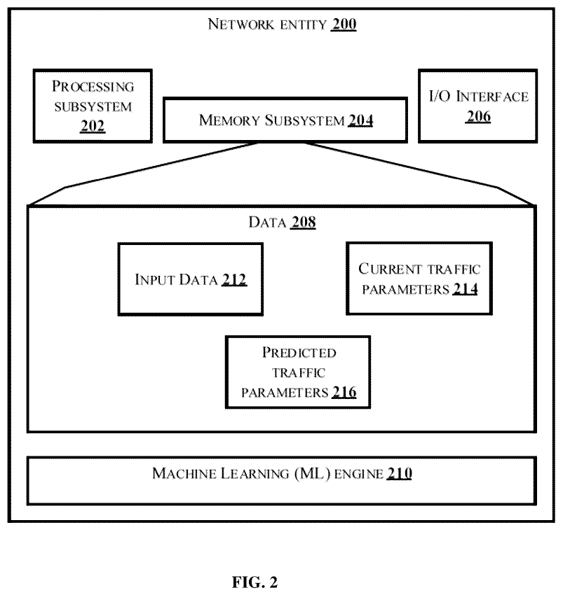

FIG. 2 illustrates a block diagram of a network entity 200 for performing dynamic resource optimization in a distributed unit node of a wireless communication network, in accordance with an embodiment of the present disclosure.

FIG. 2 is explained in conjunction with the exemplary environment 100 of FIG. 1.

In an embodiment, the network entity 200 comprises a Central Processing Unit 202 (also referred as “CPUs” or “processing subsystem 202”), a memory subsystem 204, and Input/Output (I/O) interface 206.

In an embodiment, the memory subsystem 204 may include data 208 and a Machine Learning (ML) engine 210. In an embodiment, the ML engine 210 may be a hardware unit which may be configured external to the memory subsystem 204 and coupled with the processing subsystem 202.

In one implementation, the data 208 may include, for example, input data 212, current traffic parameters 214, and predicted traffic parameters 216. It will be appreciated that the ML engine 210 may be represented as a single engine or a combination of different engines.

In an embodiment, the processing subsystem 202 may be configured to receive input data 212 including a target time of day or target day of a week for determining the associated traffic conditions.

In an embodiment, the processing subsystem 202 may be configured to monitor the current traffic condition and determine the current traffic data based on the monitored conditions.

In an embodiment, the ML engine 210 may be configured to predict traffic conditions related to the input data 212. Further, the ML engine 210 may be configured to determine the first limit and the second limit (as described in detail in FIG. 1 description and not included herein for the sake of brevity) based on the predicted traffic conditions. In an embodiment, the ML engine 210 may consider the current traffic parameters 214 and the predicted traffic parameters 216 for determining the first limit and the second limit.

A person skilled in the art will appreciate that the processing subsystem 202 may be configured to perform the steps of the present disclosure using the data 208 to perform the dynamic resource optimization in the DU 102.

A person skilled in the art will appreciate that any techniques other than the above-mentioned technique may be used to perform the steps performed by the processing subsystem 202 and the ML engine 210, which are configured to perform the dynamic resource optimization in the DU 102.

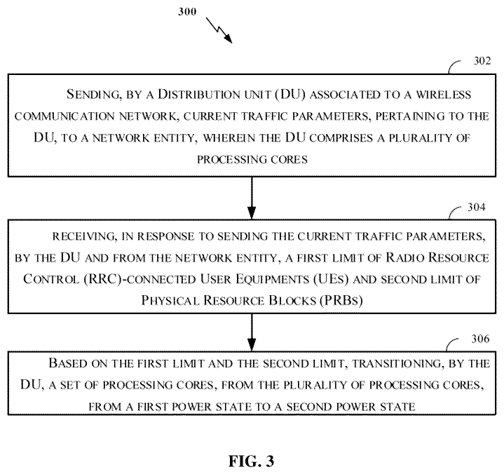

FIG. 3 illustrates an exemplary flow chart 300 illustrating method steps for performing for performing dynamic resource optimization in a distributed unit node of a wireless communication network, in accordance with some embodiments of the present disclosure.

As illustrated in FIG. 3, the method 300 may comprise one or more steps. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 302, current traffic parameters 214 pertaining to a Distribution distributed unit (DU) 102 (also referred in the present description as DU node 102) associated to a wireless communication network may be sent to the network entity. As described in FIG. 1, the DU 102 comprises a plurality of processing cores 106. The network entity may include one of the CU-CP, a near real-time Radio Access Network (RAN) Intelligent Controller (RIC), a RAN node, and a Service Management and Orchestration (SMO) framework. In an example, the SMO layer may comprise a non-real-time Radio Access Network (RAN) Intelligent Controller (RIC).

At step 304, in response to sending the current traffic parameters 214, the DU 102 may receive, from the network entity, a first limit of Radio Resource Control (RRC)-connected User Equipments (UEs) and second limit of Physical Resource Blocks (PRBs). In an embodiment, the network entity, in response to receiving the current traffic parameters 214 from the DU 102, may implement the ML engine 210 for predicting traffic parameters. In an example, the predicted traffic data may pertain to data traffic trend classified, by the ML engine 210, based on at least one of a time of a day and day of a week. For example, the ML engine 210 may be implemented, based on one or more input parameters. The ML engine 210 may be implemented to create an environment such that a learning agent, associated with the environment, may be configured to predict the traffic data.

At step 306, based on the first limit and the second limit, a set of processing cores, from the plurality of processing cores 106, may be transitioned from a first power state to a second power state. In an example, the first power state is a high power state and the second power state is a low power state. In an alternate example, the first power state is a low power state and the second power state is a high power state.

In an example embodiment, based on the current traffic data and the predicted traffic data, an rApp associated with the SMO (or an xApp associated with the near real-time RIC) may recommend the limits of PRB and RRC Connected UEs to E2 nodes associated with the communication network. Further, the E2 nodes may use provided limits to determine the number of cores needed for optimal processing and power saving. Thereafter, the E2 nodes may maintain the active cores in a default energy consumption state, and transition extra cores to a lowest energy consumption state. In an example, KPIs associated with the PRB utilization and RRC connected UEs (as described in FIG. 1) are sent over an O1 interface to the rApp. In an example, in which rApp is responsible for the core optimization: the rApp gets the 15 min KPIs for each cell, including the current traffic data. In another example, in which xApp is responsible for the core optimization: the rApp communicates appropriate policy (for example, the first core optimization policy or the second core optimization policy) based on the predicted traffic data over an AI interface, and the xApp uses subscription data from the E2 nodes as the current traffic data. Thereafter, if the predicted traffic data and the current traffic data indicate a decrease in the PRB utilization and the number of the RRC Connected UEs, then the rApp (or the xApp) inferences the new PRB and RRC Connected UE limits and recommends them to (O) DU/CU. Further, the O-DU in the RAN node gets the recommended limits from the rApp over the O1 interface (or xApp over the E2 interface if the inferencing is done at the xApp). Furthermore, using the new RRC Connected UE limit, the L2 determines the resource requirements corresponding to the new limits. Subsequently, if there are any extra cores, the L2 transitions the extra cores into a low power state. In addition, if there is a requirement of any additional cores, then the cores which are in the low power state, are transitioned back to a high power state.

In an embodiment, when the L2 indicates the new PRB limits to the L1, a scheduler begins enforcing the new PRB limit while scheduling the resources. By utilizing the new PRB limit, the L1 determines the resource requirements corresponding to the new limits. Further, if any extra cores are determined, the L1 transitions the extra cores to a low power state. In addition, if additional cores are required, then the cores already present in a low power state are transitioned back to a high power state. In an example embodiment, at O-DU, the scheduler continuously monitors the current traffic pattern at a finer-scale granularity, and makes dynamic localized decisions to override the rApp based limits for short bursts of time, based on the current traffic conditions.

In an embodiment, a dynamic limit evaluation is performed at the L2, which is used to temporarily increase the number of cores in case of a sudden traffic burst condition. Thereafter, once the traffic follows an expected trend and the sudden traffic burst condition subsides, the number of cores in use may be reversed to a last recommended stage recommended by the rApp.

In an embodiment, evaluation periods related to the traffic condition are defined in terms of number of slots where L2 checks the current load in the system to determine whether a temporary change in the number of cores is needed. In an example, an hysteresis is built into the framework to avoid ping-pong.

In an example embodiment, two PRB thresholds are defined: prbHighThreshold & prbLowThreshold corresponding to each power saving stage. Subsequently, if the average load over the evaluation period exceeds the “high” threshold, then the number of cores is to be increased. Alternatively, if the average load over the evaluation period is below the “low” threshold, then the number of cores is to be decreased. In an example, the number of cores is to be decreased based on predefined conditions related to the traffic conditions.

In an example embodiment, if in last 100 slots, average PRB used in the gNB is greater than prbHighThreshold and the current Energy Stage is not S1 (corresponding to the maximum energy consumption): the method of the present subject matter comprises transitioning to next ES Stage which provides a greater number of PRBs. For example, L2 transitions the extra cores needed from C6 to C0 state. Further, L1 is intimated of the new PRB limit corresponding to the new ES Stage. In addition, L1 in turn transitions the extra cores needed from C6 to C0 state.

In another example embodiment, if in last 1000 slots, the average PRB used in the gNB is lesser than prbLowThreshold, the method of the present subject matter comprises transitioning to next ES Stage which provides lesser PRBs (the lowest energy consumption ES stage possible at any instance is limited to the one recommended by the rApp). For example, L2 transitions the extra cores from C0 to C6 state. Further, L1 is intimated of the new PRB limit corresponding to the new ES Stage. In addition, L1 transitions the extra cores from C0 to C6 state. In an example, any changes in L1 core are driven solely by the PRB limit communicated from L2 to L1.

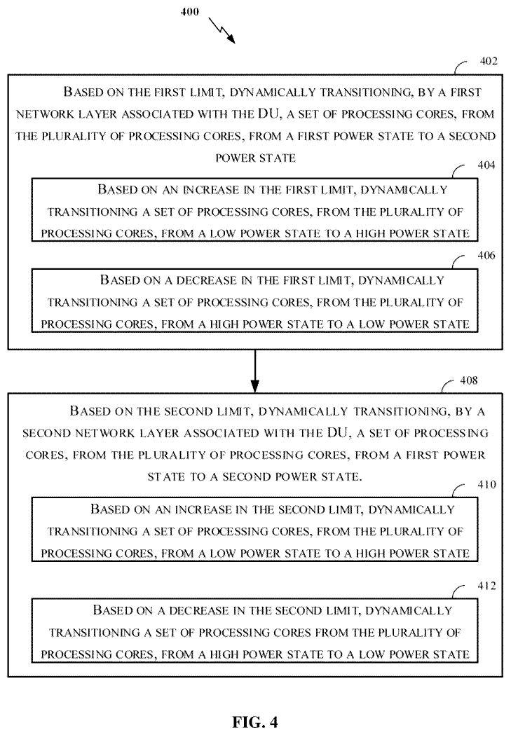

FIG. 4 illustrates an exemplary flow chart illustrating method steps for performing for performing dynamic resource optimization in a distributed unit node of a wireless communication network, in accordance with some embodiments of the present disclosure.

As illustrated in FIG. 4, the method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 402, based on the first limit, a set of processing cores 106, from the plurality of processing cores 106, may be dynamically transitioned from a first power state to a second power state by the first network layer associated with the DU 102.

At step 404, based on an increase in the first limit, a set of processing cores 106 may be dynamically transitioned from a low power state to a high power state.

At step 406, based on a decrease in the first limit, a set of processing cores 106 may be dynamically transitioned from a high power state to a low power state.

At step 408, based on the second limit, a set of processing cores 106, from the plurality of processing cores 106 may be dynamically transitioned from a first power state to a second power state by a second network layer associated with the DU 102.

At step 410, based on an increase in the second limit, a set of processing cores 106 may be dynamically transitioned from a low power state to a high power state.

At step 412, based on a decrease in the second limit, a set of processing cores 106 may be dynamically transitioned from a high power state to a low power state.

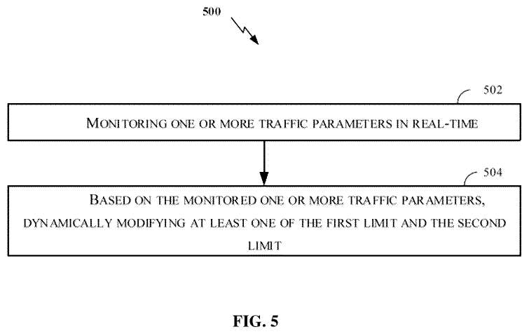

FIG. 5 illustrates an exemplary flow chart illustrating method steps for performing for performing dynamic resource optimization in a distributed unit node of a wireless communication network, in accordance with some embodiments of the present disclosure.

As illustrated in FIG. 5, the method 500 may comprise one or more steps. The method 500 may be described in the general context of computer executable instructions. Generally, computer executable instructions can include routines, programs, objects, components, data structures, procedures, modules, and functions, which perform particular functions or implement particular abstract data types.

The order in which the method 500 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 502, one or more traffic parameters may be monitored in real-time.

At step 504, based on the monitored one or more traffic parameters, at least one of the first limit and the second limit may be dynamically modified.

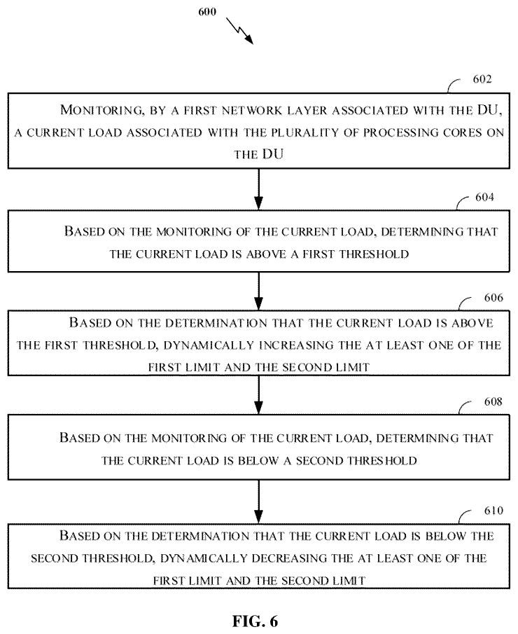

FIG. 6 illustrates an exemplary flow chart illustrating method steps for performing for performing dynamic resource optimization in a distributed unit node of a wireless communication network, in accordance with some embodiments of the present disclosure.

As illustrated in FIG. 6, the method 600 may comprise one or more steps. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 602, a current load associated with the plurality of processing cores 106 on the DU 102, may be monitored by a first network layer associated with the DU 102.

At step 604, based on the monitoring of the current load, it may be determined that the current load is above a first threshold.

Further, at step 606, based on the determination that the current load is above the first threshold, the at least one of the first limit and the second limit may be dynamically increased.

At step 608, based on the monitoring of the current load, it may be determined that the current load is below a second threshold.

Further, at step 610, based on the determination that the current load is below the second threshold, the at least one of the first limit and the second limit may be dynamically decreased.

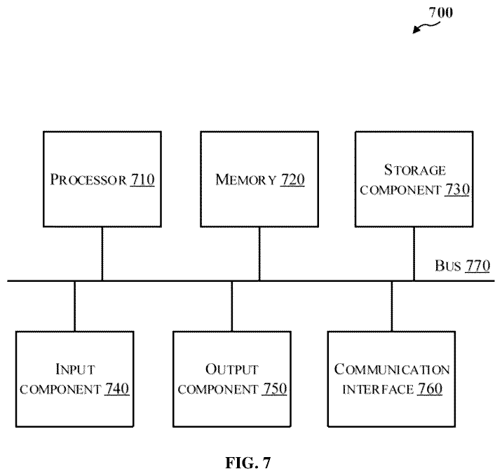

FIG. 7 illustrates an embodiment of a device wherein the method for performing for performing dynamic resource optimization in a distributed unit node of a wireless communication network may be implemented, according to the embodiments as disclosed herein. It will be appreciated that the device 700 is associated with the DU 102. As shown in FIG. 7, the device 700 comprises a processor 710, a memory 720, a storage component 730, an input component 740, an output component 750, a communication interface 760, and a bus 770.

The processor 710, as used herein, means any type of computational circuit that may comprise hardware elements and software elements. The processor 710 may be embodied as a multi-core processor, a single core processor, or a combination of one or more multi-core processors and/or one or more single core processors, a distributed processing system, or the like. The processor 710 may be a Central Processing Unit (CPU), a graphics processing unit (GPU), an accelerated processing unit (APU), an application-specific integrated circuit (ASIC), or another type of processing component.

Memory 720 includes a non-transitory computer readable medium. Memory 720 includes a random-access memory (RAM), a read only memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 cause the processor 710 to perform one or more method steps of an embodiment described above.

Storage component 730 stores information and/or software related to the operation and use of the device 700. For example, storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 740 is configured to receive information, such as user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

Output component 750 is configured to provide output information from the device 700. For example, the output component 750 may be, but not limited to, a display, a speaker, instructions to an external device, and/or one or more light-emitting diodes (LEDs).

Communication interface 760 is an interface that provides a communication connection to other devices, such as external devices and internal devices. The connection by the communication interface 760 can be a wired connection, a wireless connection, or a combination of wired and wireless connections, and can be a direct connection or an indirect connection via a communication network that exists between the device 700 and other devices. In other words, the standard of the communication interface 760 is not limited.

The bus 770 acts as an interconnect between the processor 710, the memory 720, the storage component 730, the input component 740, the output component 750, and the communication interface 760 of the device 700. The bus 770 may include a wired interconnection or a wireless interconnection.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700. Further, one or more method steps described in any of the embodiments may be performed utilizing a plurality of devices 700 in communication with one another.

In an embodiment [1], a method comprising: sending, by a Distribution unit (DU) associated to a wireless communication network, current traffic parameters, pertaining to the DU, to a network entity, wherein the DU comprises a plurality of processing cores; in response to sending the current traffic parameters, receiving, by the DU and from the network entity, a first limit of Radio Resource Control (RRC)-connected User Equipments (UEs) and second limit of Physical Resource Blocks (PRBs); and based on the first limit and the second limit, transitioning, by the DU, a set of processing cores, from the plurality of processing cores, from a first power state to a second power state.

In an embodiment [2], in the method, described in the embodiment [1], the transitioning of the set of cores comprises: based on the first limit, dynamically transitioning, by a first network layer associated with the DU, a set of processing cores, from the plurality of processing cores, from a first power state to a second power state.

In an embodiment [3], in the method, described in the embodiment [1], the transitioning of the set of cores comprises: based on the second limit, dynamically transitioning, by a second network layer associated with the DU, a set of processing cores, from the plurality of processing cores, from a first power state to a second power state.

In an embodiment [4], in the method, described in the embodiment [1], the transitioning of the set of cores comprises, based on an increase in the first limit, dynamically transitioning a set of processing cores, from the plurality of processing cores, from a low power state to a high power state.

In an embodiment [5], in the method, described in the embodiment [1], the transitioning of the set of cores comprises, based on a decrease in the first limit, dynamically transitioning a set of processing cores, from the plurality of processing cores, from a high power state to a low power state.

In an embodiment [6], the method described in the embodiment [1], the transitioning of the set of cores comprises, based on an increase in the second limit, dynamically transitioning a set of processing cores, from the plurality of processing cores, from a low power state to a high power state.

In an embodiment [7], the method described in the embodiment [1], the transitioning of the set of cores comprises, based on a decrease in the second limit, dynamically transitioning a set of processing cores from the plurality of processing cores, from a high power state to a low power state.

In an embodiment [8], in the method described in the embodiment [1], in response to sending the current traffic parameters by the DU to the network entity, the network entity is to implement a Machine Learning (ML) engine for predicting traffic parameters based on, and determine the first limit and the second limit, based on the current traffic parameters, received from the DU, and the predicted traffic parameters.

In an embodiment [9], in the method, described in the embodiment [1], further comprises: monitoring one or more traffic parameters in real-time; and based on the monitored one or more traffic parameters, dynamically modifying at least one of the first limit and the second limit.

In an embodiment [10], in the method described in the embodiment [1], further comprises: monitoring, by a first network layer associated with the DU, a current load associated with the plurality of processing cores on the DU; based on the monitoring of the current load, determining that the current load is above a first threshold; based on the determination that the current load is above the first threshold, dynamically increasing the at least one of the first limit and the second limit; based on the monitoring of the current load, determining that the current load is below a second threshold; and based on the determination that the current load is below the second threshold, dynamically decreasing the at least one of the first limit and the second limit.

In an embodiment [11], in the method described in the embodiment [1], the network entity comprises one of a Control Unit-Control Plane (CU-CP), a near real-time Radio Access Network (RAN) Intelligent Controller (RIC), a RAN node, and a Service Management and Orchestration (SMO) framework, wherein the SMO layer comprises a non-real-time Radio Access Network (RAN) Intelligent Controller (RIC).

In an embodiment [12], in the method described in the embodiment [1], the current traffic data pertains to Key Performance Indicators (KPIs) associated with the RRC-connected UEs and the PRBs.

In an embodiment [13], in the method described in the embodiment [1], the predicted traffic data pertains to data traffic trend classified based on at least one of a time of a day and day of a week.

In an embodiment [14], an apparatus is configured to: send, by a Distribution unit (DU) associated to a wireless communication network, current traffic parameters, pertaining to the DU, to a network entity, wherein the DU comprises a plurality of processing cores; in response to sending the current traffic parameters, receive, by the DU and from the network entity, a first limit of Radio Resource Control (RRC)-connected User Equipments (UEs) and second limit of Physical Resource Blocks (PRBs); and based on the first limit and the second limit, transition, by the DU, a set of processing cores, from the plurality of processing cores, from a first power state to a second power state.

In an embodiment [15], the apparatus, described in the embodiment [14], to transition the set of cores, is configured to: based on the first limit, dynamically transition, by a first network layer associated with the DU, a set of processing cores, from the plurality of processing cores, from a first power state to a second power state.

In an embodiment [16], the apparatus, described in the embodiment [14], to transition the set of cores, is configured to: based on the second limit, dynamically transition, by a second network layer associated with the DU, a set of processing cores, from the plurality of processing cores, from a first power state to a second power state.

In an embodiment [17], the apparatus, described in the embodiment [14], to transition the set of cores, is configured to, based on an increase in the first limit, dynamically transition a set of processing cores from, the plurality of processing cores, from a low power state to a high power state.

In an embodiment [18], the apparatus described in the embodiment [14], to transition the set of cores, is configured to, based on a decrease in the first limit dynamically transition a set of processing cores from, the plurality of processing cores, from a high power state to a low power state.

In an embodiment [19], the apparatus described in the embodiment [14], to transition the set of cores, is configured to, based on an increase in the second limit dynamically transition a set of processing cores, from the plurality of processing cores, from a low power state to a high power state.

In an embodiment [20], the apparatus described in the embodiment [14], to transition the set of cores, is configured to, based on a decrease in the second limit dynamically transition a set of processing cores, from the plurality of processing cores, from a high power state to a low power state.

In an embodiment [21], in the apparatus described in the embodiment [14], in response to sending the current traffic parameters by the DU to the network entity, the network entity is to implement a Machine Learning (ML) engine for predicting traffic parameters based on, and determine the first limit and the second limit, based on the current traffic parameters, received from the DU, and the predicted traffic parameters.

In an embodiment [22], the apparatus described in the embodiment [14], is configured to monitor one or more traffic parameters in real-time; and dynamically modify at least one of the first limit and the second limit.

In an embodiment [23], the apparatus described in the embodiment [14], is configured to: monitor, by a first network layer associated with the DU, a current load associated with the plurality of processing cores on the DU; based on the monitoring of the current load, determine that the current load is above a first threshold; based on the determination that the current load is above the first threshold, dynamically increasing the at least one of the first limit and the second limit; based on the monitoring of the current load, determining that the current load is below a second threshold; and based on the determination that the current load is below the second threshold, dynamically decreasing the at least one of the first limit and the second limit.

In an embodiment [24], in the apparatus described in the embodiment [14], the network entity comprises one of a Control Unit-Control Plane (CU-CP), a near real-time Radio Access Network (RAN) Intelligent Controller (RIC), a RAN node, and a Service Management and Orchestration (SMO) framework, wherein the SMO layer comprises a non-real-time Radio Access Network (RAN) Intelligent Controller (RIC).

In an embodiment [25], in the apparatus described in the embodiment [14], the current traffic data pertains to Key Performance Indicators (KPIs) associated with the RRC-connected UEs and the PRBs.

In an embodiment [26], in the apparatus described in the embodiment [14], the predicted traffic data pertains to data traffic trend classified, by the ML engine, based on at least one of a time of a day and day of a week.

In an embodiment [27], a non-transitory computer-readable medium having program instructions stored thereon, executed by an apparatus for wireless communication, is disclosed. The program instructions may comprise: sending, by a Distribution unit (DU) associated to a wireless communication network, current traffic parameters, pertaining to the DU, to a network entity, wherein the DU comprises a plurality of processing cores; in response to sending the current traffic parameters, receiving, by the DU and from the network entity, a first limit of Radio Resource Control (RRC)-connected User Equipments (UEs) and second limit of Physical Resource Blocks (PRBs); and based on the first limit and the second limit, transitioning, by the DU, a set of processing cores, from the plurality of processing cores, from a first power state to a second power state.

In a non-limiting embodiment of the present disclosure, one or more non-transitory computer-readable media may be utilized for implementing the embodiments consistent with the present disclosure. A computer-readable medium refers to any type of physical memory (such as the memory 720) on which information or data readable by a processor may be stored. Thus, a computer-readable media may store one or more instructions for execution by the at least one processor 710, including instructions for causing the at least one processor 710 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The various illustrative logical blocks, modules, and operations described in connection with the present disclosure may be implemented or performed with a general-purpose processor, discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a plurality of microprocessors, or any other such configuration.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method comprising:
sending, by a Distribution unit (DU) associated to a wireless communication network, current traffic parameters, pertaining to the DU, to a network entity, wherein the DU comprises a plurality of processing cores;
receiving, in response to sending the current traffic parameters, by the DU and from the network entity, a first limit of Radio Resource Control (RRC)-connected User Equipments (UEs) and second limit of Physical Resource Blocks (PRBs); and
based on the first limit and the second limit, transitioning, by the DU, a set of processing cores, from the plurality of processing cores, from a first power state to a second power state.

2. The method as claimed in claim 1, wherein the transitioning of the set of processing cores comprises:
based on the first limit, dynamically transitioning, by a first network layer associated with the DU, the set of processing cores, from the plurality of processing cores, from the first power state to the second power state.

3. The method as claimed in claim 1, wherein the transitioning of the set of processing cores comprises:
based on the second limit, dynamically transitioning, by a second network layer associated with the DU, the set of processing cores, from the plurality of processing cores, from the first power state to the second power state.

4. The method as claimed in claim 1, wherein the transitioning of the set of processing cores comprises, based on an increase in the first limit, dynamically transitioning the set of processing cores, from the plurality of processing cores, from a low power state to a high power state.

5. The method as claimed in claim 1, wherein the transitioning of the set of processing cores comprises, based on a decrease in the first limit, dynamically transitioning the set of processing cores, from the plurality of processing cores, from a high power state to a low power state.

6. The method as claimed in claim 1, wherein the transitioning of the set of processing cores comprises, based on an increase in the second limit, dynamically transitioning the set of processing cores, from the plurality of processing cores, from a low power state to a high power state.

7. The method as claimed in claim 1, wherein the transitioning of the set of processing cores comprises, based on a decrease in the second limit, dynamically transitioning the set of processing cores from the plurality of processing cores, from a high power state to a low power state.

8. The method as claimed in claim 1, wherein, in response to sending the current traffic parameters by the DU to the network entity, the network entity is to implement a Machine Learning (ML) engine for predicting traffic parameters, and determine the first limit and the second limit, based on the current traffic parameters, received from the DU, and predicted traffic parameters.

9. The method as claimed in claim 1, wherein the method comprises:
monitoring one or more traffic parameters in real-time; and
based on the monitored one or more traffic parameters, dynamically modifying at least one of the first limit and the second limit.

10. The method as claimed in claim 1, wherein the method comprises:
monitoring, by a first network layer associated with the DU, a current load associated with the plurality of processing cores on the DU;
based on the monitoring of the current load, determining that the current load is above a first threshold;
based on the determination that the current load is above the first threshold, dynamically increasing the at least one of the first limit and the second limit;
based on the monitoring of the current load, determining that the current load is below a second threshold; and
based on the determination that the current load is below the second threshold, dynamically decreasing the at least one of the first limit and the second limit.

11. The method as claimed in claim 8, wherein the current traffic data pertains to Key Performance Indicators (KPIs) associated with the RRC-connected UEs and the PRBs, and wherein the predicted traffic parameters pertains to data traffic trend classified, by the ML engine, based on at least one of a time of a day and day of a week, and the predicted traffic parameters pertains to data traffic trend classified, by the ML engine, based on at least one of a time of a day and day of a week.

12. An apparatus configured to:
send, by a Distribution unit (DU) associated to a wireless communication network, current traffic parameters, pertaining to the DU, to a network entity, wherein the DU comprises a plurality of processing cores;
receive, in response to sending the current traffic parameters, by the DU and from the network entity, a first limit of Radio Resource Control (RRC)-connected User Equipments (UEs) and second limit of Physical Resource Blocks (PRBs); and
based on the first limit and the second limit, transition, by the DU, a set of processing cores, from the plurality of processing cores, from a first power state to a second power state.

13. The apparatus as claimed in claim 12, wherein, to transition the set of processing cores, the apparatus is configured to:
based on the first limit, dynamically transition, by a first network layer associated with the DU, the set of processing cores, from the plurality of processing cores, from the first power state to the second power state;
monitor one or more traffic parameters in real-time; and
dynamically modify at least one of the first limit and the second limit.

14. The apparatus as claimed in claim 12, wherein, to transition the set of processing cores, the apparatus is configured to:
based on the second limit, dynamically transition, by a second network layer associated with the DU, the set of processing cores, from the plurality of processing cores, from the first power state to the second power state;
monitor, by a first network layer associated with the DU, a current load associated with the plurality of processing cores on the DU;
based on the monitoring of the current load, determine that the current load is above a first threshold;
based on the determination that the current load is above the first threshold, dynamically increasing the at least one of the first limit and the second limit;
based on the monitoring of the current load, determining that the current load is below a second threshold; and
based on the determination that the current load is below the second threshold, dynamically decreasing the at least one of the first limit and the second limit.

15. The apparatus as claimed in claim 12, wherein, to transition the set of processing cores, the apparatus is configured to, based on an increase in the first limit, dynamically transition the set of processing cores from, the plurality of processing cores, from a low power state to a high power state, and the network entity comprises one of a Control Unit-Control Plane (CU-CP), a near real-time Radio Access Network (RAN) Intelligent Controller (RIC), a RAN node, and a Service Management and Orchestration (SMO) framework, wherein the SMO layer comprises a non-real-time Radio Access Network (RAN) Intelligent Controller (RIC).

16. The apparatus as claimed in claim 12, wherein, to transition the set of processing cores, the apparatus is configured to, based on a decrease in the first limit dynamically transition the set of processing cores from, the plurality of processing cores, from a high power state to a low power state, and current traffic data pertains to Key Performance Indicators (KPIs) associated with the RRC-connected UEs and the PRBs.

17. The apparatus as claimed in claim 12, wherein, to transition the set of processing cores, the apparatus is configured to, based on an increase in the second limit dynamically transition the set of processing cores, from the plurality of processing cores, from a low power state to a high power state.

18. The apparatus as claimed in claim 12, wherein, to transition the set of processing cores, the apparatus is configured to, based on a decrease in the second limit dynamically transition the set of processing cores, from the plurality of processing cores, from a high power state to a low power state.

19. The apparatus as claimed in claim 12, wherein, in response to sending the current traffic parameters by the DU to the network entity, the network entity is to implement a Machine Learning (ML) engine for predicting traffic parameters based on, and determine the first limit and the second limit, based on the current traffic parameters, received from the DU, and the predicted traffic parameters.

20. A non-transitory computer-readable medium having program instructions stored thereon, executed by an apparatus for wireless communication, for:
sending, by a Distribution unit (DU) associated to a wireless communication network, current traffic parameters, pertaining to the DU, to a network entity, wherein the DU comprises a plurality of processing cores;
receiving, in response to sending the current traffic parameters, by the DU and from the network entity, a first limit of Radio Resource Control (RRC)-connected User Equipments (UEs) and second limit of Physical Resource Blocks (PRBs); and
based on the first limit and the second limit, transitioning, by the DU, a set of processing cores, from the plurality of processing cores, from a first power state to a second power state.
